(19) United States
(12) Patent Application Publication
(10) Pub. No.: US 2008/0098989 A1
(43) Pub. Date: May 1, 2008

(54) Fuel-injection system

(75) Inventor: Michael Patrick Harmon, Dunlap, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/589,830

(22) Filed: Oct. 31, 2006

(51) Int. Cl. F02M 55/02; F02M 69/46

(52) U.S. Cl. 123/469; 123/456

(57) ABSTRACT

A fuel-injection system for an engine has a plurality of fuel-system components, including a pump, a fuel injector, and a plurality of fuel-system components connecting the pump to the fuel injector. A portion of the fuel-injection system from the pump to the fuel injector may include a first joint mating a first pair of the fuel-system components, a second joint mating a second pair of the fuel-system components, and a third joint mating a third pair of the fuel-system components. Each of the first joint, the second joint, and the third joint may include a curved surface and a corresponding seat that are mated to one another and that provide a substantially fluid-tight seal and allow variation in the angular relationship between the associated pair of fuel-system components.

### TECHNICAL FIELD

The present disclosure relates to fuel-injection systems for engines and, more particularly, to methods of connecting components of fuel-injection systems.

### BACKGROUND

Many engines have a fuel-injection system for metering fuel that the engine combusts. Fuel-injection systems typically include a fuel injector and one or more fuel-system components that connect to the fuel injector and supply fluid to it. In many fuel-injection systems, the structures at each of the joints between components of the fuel-injection system provide little or no flexibility to tolerate variations in angular and/or positional relationships between the components. For example, many fuel-injection systems use threaded connections at each of the joints between its components. Assembling such a fuel-injection system may require bending or otherwise flexing one or more fuel-system components to compensate for manufacturing tolerances and align the joints between the various components. Additionally, during operation of such a fuel-injection system, various components of the fuel-injection system may need to flex to accommodate movement between the components.

Many fuel-injection systems address these issues at least in part by including at least some relatively flexible components among those that supply fluid to the fuel injector. For example, many fuel-injection systems use relatively thin-walled tubing to carry fuel to the fuel injector. Such tubing can bend relatively easily to facilitate connecting it to other components of the fuel-injection system. Additionally, such tubing can flex to accommodate movement between components of the fuel-injection system during operation. Unfortunately, supplying fluid to a fuel injector through relatively thin-walled tubing may require limiting the pressure at which the fluid is supplied to the fuel injector to undesirably low levels because of the relatively low pressure capacity of the tubing.

Published U.S. Patent Application No. 2006/0021601 A1 to Schmieder (“the '601 application”) shows a fuel-injection system that includes joints that accommodate variation in the relative positions of the fuel-injection system's components. The fuel-injection system shown by the '601 application includes a fuel injector mounted within a bore in a cylinder head with an inlet of the fuel injector facing upward. The fuel-injection system further includes a fuel rail mounted to the cylinder head. The fuel rail includes a base mounted to the cylinder head, legs that extend upwardly from the base, and a conduit supported by the legs and disposed generally above the fuel injector. Above the inlet of the fuel injector, the fuel rail includes an outlet from the conduit.

The fuel-injection system of the '601 application further includes a passage sandwiched between and fluidly connecting the outlet of the fuel rail and the inlet of the fuel injector. Compression force on the passage holds together a first joint between the passage and the outlet of the fuel rail and a second joint between the passage and the inlet of the fuel injector. The first joint has a configuration that allows variation in the angular relationship between the passage and the fuel rail. The second joint has a similar configuration that allows variation in the angular relationship between the passage and the fuel injector. Thus, the first joint and the second joint collectively accommodate variation in the positions of the outlet of the fuel rail and the inlet of the fuel injector in horizontal directions by allowing the passage to tilt at various angles between them.

Although the fuel-injection system disclosed by the '601 application includes joints that allow variation in the angular relationships between the components mated by the joints, certain disadvantages persist. For example, these joints only accommodate variation in the relative positions of components in two directions. Additionally, in the design disclosed by the '601 application, the force holding the first joint and the second joint together will depend primarily on the free length of the passage, the mechanical properties of the passage, and the distance between the outlet of the fuel rail and the inlet of the fuel injector. Without tight manufacturing tolerances, these factors could vary considerably, which could result in either undesirably low or undesirably high force holding the first and second joints together. Furthermore, connecting the fuel rail to the fuel injector by sandwiching a passage between them may necessitate moving the fuel rail to disconnect the fuel injector and the fuel rail.

The fuel-injection system and methods of the present disclosure solve one or more of the problems set forth above.

### SUMMARY OF THE INVENTION

One disclosed embodiment relates to a fuel-injection system for an engine. The fuel-injection system may have a plurality of fuel-system components, which may include a pump, a fuel injector, and a plurality of fuel-system components connecting the pump to the fuel injector. A portion of the fuel-injection system from the pump to the fuel injector may include a first joint mating a first pair of the fuel-system components, a second joint mating a second pair of the fuel-system components, and a third joint mating a third pair of the fuel-system components. Each of the first joint, the second joint, and the third joint may include a curved surface and a corresponding seat that are mated to one another and that provide a substantially fluid tight seal and allow variation in the angular relationship between the associated pair of fuel-system components.

Another embodiment relates to a method of connecting fuel-system components of a fuel-injection system for an engine. The fuel-system component may include a pump, a fuel injector, and one or more fuel-system components for carrying fluid between the pump and the fuel injector. The method may include mating a first pair of the fuel-system components with a first joint, including mating a first curved surface and a corresponding first seat that provide a substantially fluid-tight seal and allow variation in the angular relationship between the first pair of fuel-system components, wherein mating the first curved surface and the first seat includes clamping the first joint together with an adjustable clamp. The method may also include mating a second pair of the fuel-system components with a second joint, including mating a second curved surface and corresponding second seat that provide a substantially fluid-tight seal and allow variation in the angular relationship between the second pair of fuel-system components, wherein mating the second curved surface and the second seat includes clamping the second joint together with an adjustable clamp.

A further embodiment relates to a fuel-injection system for an engine. The fuel-injection system may include a first fuel-system component, a second fuel-system component, and a plurality of fuel-system components connecting the first fuel-system component and the second fuel-system component. The plurality of fuel-system components connecting the first fuel-system component and the second fuel-system component may include a first passage and a second passage connected to the first passage. The second passage may extend at an angle to the first passage. A portion of the fuel-injection system from the first fuel-system component to the second fuel-system component may include a first joint that mates a first pair of the fuel-system components and a second joint that mates a second pair of the fuel-system components. Each of the first joint and the second joint may include a curved surface and a corresponding seat that are mated to one another and that provide a substantially fluid-tight seal and allow variation in the angular relationship between the associated pair of fuel-system components.

### BRIEF DESCRIPTION OF THE DRAWINGS

FIG. 1A is a plan view of an engine with a fuel-injection system according to the present disclosure;

FIG. 1B is an elevation view of the engine and fuel-injection system shown in FIG. 1A;

FIG. 1C is a sectional view of the engine and fuel-injection system shown in FIGS. 1A and 1B through line 1C-1C shown in FIG. 1B; and

FIG. 1D is a sectional view of the engine and fuel-injection system shown in FIGS. 1A and 1B through line 1D-1D in FIG. 1A.

### DETAILED DESCRIPTION

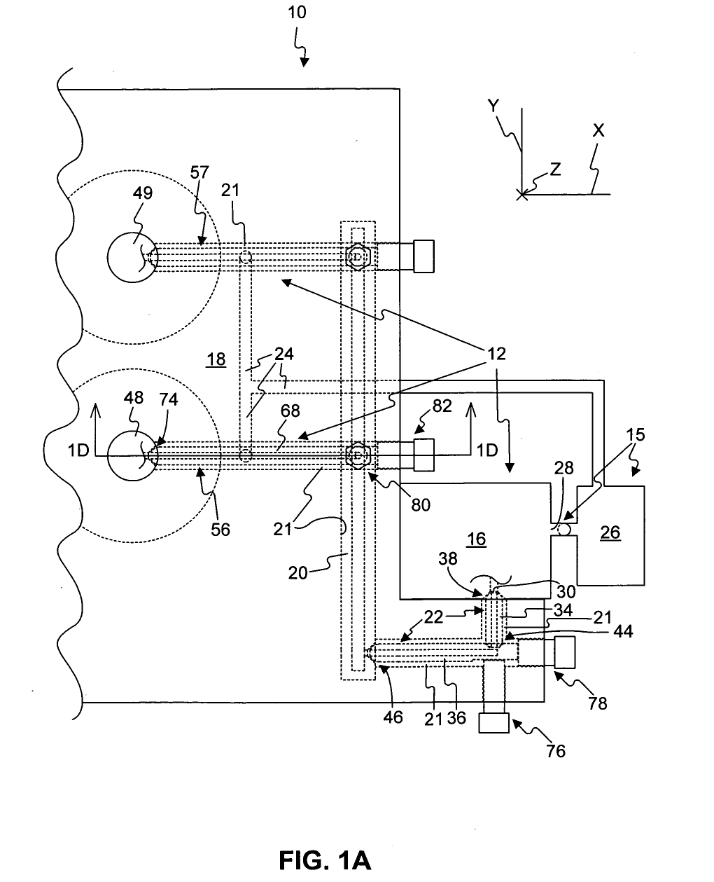

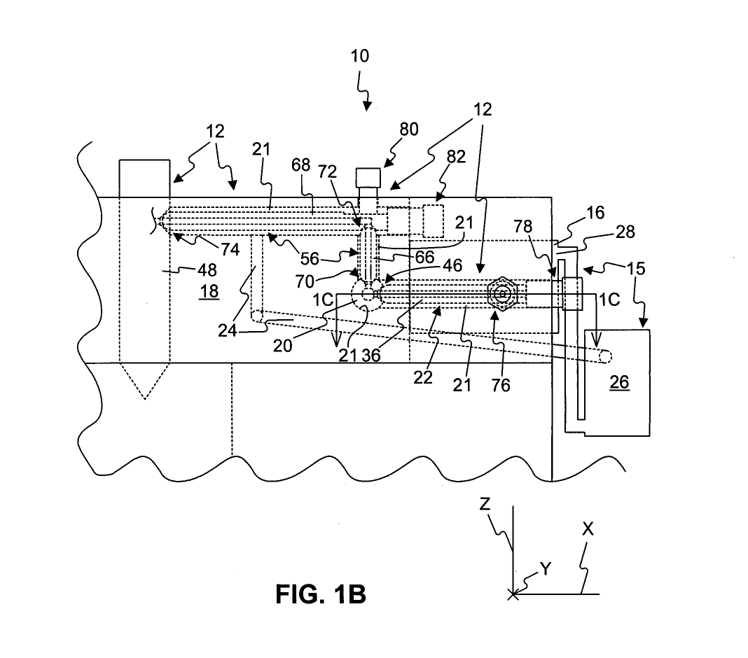

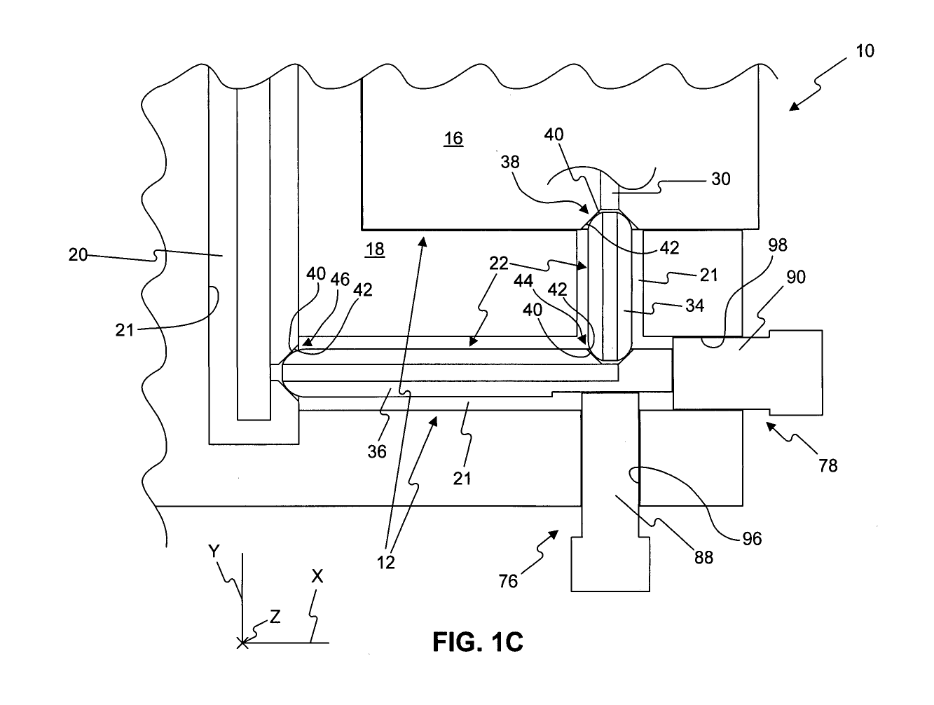

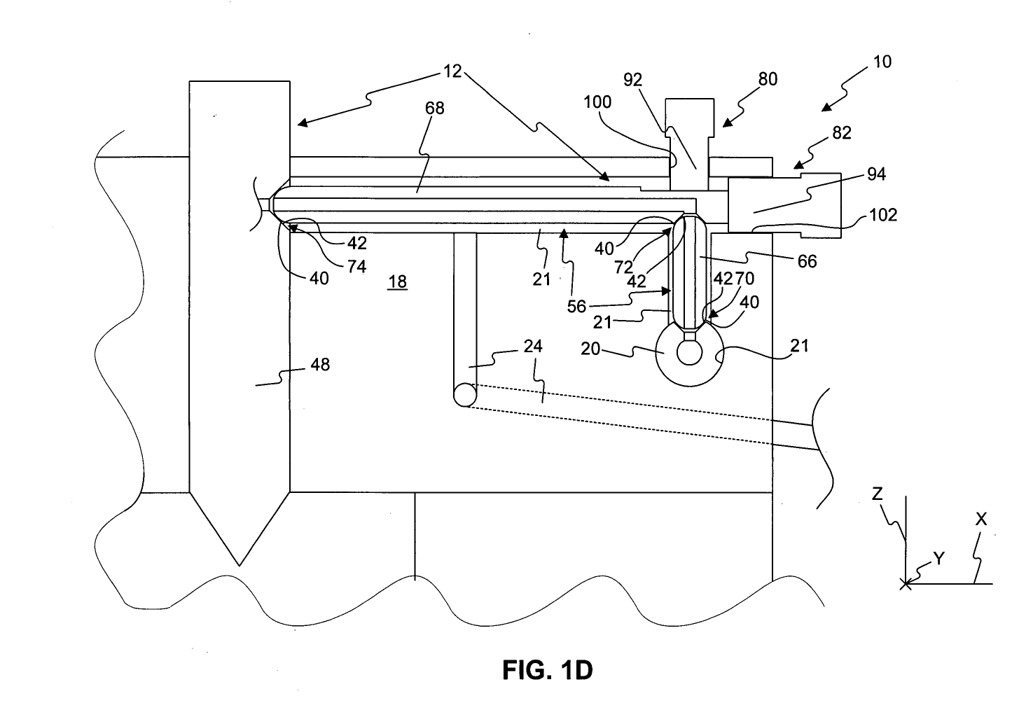

FIGS. 1A-1D show an engine 10 and one embodiment of a fuel-injection system 12 for engine 10. Fuel-injection system 12 may comprise various fuel-system components, including a pump 16, fuel injectors 48 and 49, one or more fuel-system components serving as a fluid source 15 for pump 16, and one or more fuel-system components fluidly connecting pump 16 to one or both of fuel injectors 48, 49. In some embodiments, the fuel-system components between pump 16 and fuel injectors 48, 49 may include a manifold 20, one or more fuel-system components forming a main supply line 22, and one or more fuel-system components forming injector-supply lines 56 and 57.

An enclosure, such as a cylinder head 18 of engine 10, may substantially surround some portions of fuel-injection system 12. For example, main supply line 22, manifold 20, and injector-supply lines 56, 57 may extend through substantially enclosed cavities 21 in cylinder head 18. As FIGS. 1A-1D show, in some embodiments, manifold 20 may have substantially the same cross-section as the adjacent cavity walls, such that the adjacent cavity walls may contact and support manifold 20. Additionally, as FIGS. 1A, 1B, and 1D show, drain passages 24 may extend from cavities 21. In some embodiments, drain passages 24 may be fluidly connected to fluid source 15.

Fluid source 15 may include any component or components that supply fluid to pump 16. Fluid source 15 may supply pump 16 with fuel that engine 10 will ultimately combust. Alternatively, fluid source 15 may supply a fluid other than fuel, such as engine oil, for another purpose. In some embodiments, fluid source 15 may supply fluid to other components, in addition to pump 16. Fluid source 15 may include a reservoir 26 in fluid communication with an inlet 28 of pump 16. As FIGS. 1A and 1B show, reservoir 26 may be located at a distance from engine 10. Alternatively, reservoir 26 may mount to or form part of engine 10. In some embodiments, in addition to reservoir 26, fluid source 15 may include various other components, such as passages, valves, and/or other pumps, that fluidly connect inlet 28 of pump 16 to reservoir 26. Alternatively, inlet 28 of pump 16 may receive fluid directly from reservoir 26.

Pump 16 may be any type of device operable to receive fluid at inlet 28 and drive at least a portion of that fluid out of an outlet 30. For example, pump 16 may be a piston pump, a centrifugal pump, a gear pump, a vane pump, a diaphragm pump, or any other type of device with one or more mechanisms for driving fluid from inlet 28 to outlet 30. In some embodiments and/or circumstances, pump 16 and fuel-injection system 12 may be configured such that pump 16 delivers fluid at relatively high pressures, such as more than 10,000 PSI. As FIGS. 1A and 1C show, pump 16 may mount directly to engine 10. Alternatively, pump 16 may be disposed at a distance from engine 10.

Main supply line 22 may include any component or components that fluidly connect outlet 30 of pump 16 to manifold 20. For example, as FIG. 1C shows, main supply line 22 may include a passage 34 fluidly connected to an outlet 30 of pump 16 and a passage 36 fluidly connected between passage 34 and manifold 20. Passage 36 may extend at an angle to passage 34.

Manifold 20 may include any component or assembly of components that fluidly connect main supply line 22 to injector-supply lines 56, 57. For example, as FIGS. 1A-1D show, manifold 20 may include a passage fluidly connected at different points to main supply line 22 and injector-supply lines 56, 57.

Each injector-supply line 56, 57 may include any component or components that fluidly connect manifold 20 to a fuel injector 48, 49. For example, as FIG. 1D shows, injector-supply line 56 may include a passage 66 fluidly connected to manifold 20 and a passage 68 fluidly connected between passage 66 and fuel injector 48. Passage 66 and passage 68 may extend at an angle to one another. Injector-supply line 57 may include components similar to injector-supply line 56.

The portion of fuel-injection system 12 from pump 16 to fuel injectors 48, 49 may include various types of joints mating the fuel-system components thereof to one another. In some embodiments, one or more of the joints in this portion of fuel-injection system 12 may have a configuration that allows variation in the angular relationship between the pair of fuel-system components mated thereby. For example, a joint 38 that mates passage 34 and outlet 30 of pump 16 may have a configuration that allows mating passage 34 in any of multiple possible angular relationships with respect to pump 16. In some embodiments, joint 38 may have a configuration that allows independent variation of the angular relationship between passage 34 and pump 16 about each of an X axis, a Y axis, and a Z axis (shown in FIGS. 1A-1D) while still providing a substantially fluid-tight seal between passage 34 and pump 16. Joint 38 may have various different configurations that allow it to function in this manners.

In some embodiments, joint 38 may include a curved surface 40 on passage 34 abutting a corresponding seat 42 on pump 16. Curved surface 40 may have a shape with a substantially constant radius of curvature, such as a substantially spherical shape, as FIGS. 1A-1D show, or a toroidal shape. Seat 42 may have a shape that allows curved surface 40 to make line contact with seat 42 to provide a substantially fluid-tight seal between passage 34 and pump 16 with passage 34 and pump 16 in various different angular relationships. For example, as FIG. 1C best shows, in embodiments where curved surface 40 has a substantially spherical shape, seat 42 may have a tapered shape with at least one substantially circular cross-section that curved surface 40 can make line contact with in various different angular orientations. Similarly, in embodiments where curved surface 40 has a substantially spherical shape, seat 42 may alternatively include a substantially circular edge that curved surface 40 may make line contact with in various different angular orientations.

Various materials may form curved surface 40 and seat 42. In some embodiments, relatively rigid materials, such as metal, ceramic material, hard plastic, or another similarly rigid material, may form curved surface 40 and/or seat 42. Similarly, in some embodiments, coatings applied to such relatively rigid materials may form curved surface 40 and/or seat 42.

In addition to joint 38, the portion of fuel-injection system 12 from pump 16 to fuel injectors 48, 49 may include additional joints that provide a substantially fluid-tight seal and allow variation in the angular relationship between the pair of fuel-system components mated thereby. For example, as FIG. 1C best shows, fuel-injection system 12 may include such a joint 44 that mates passages 34, 36, and such a joint 46 that mates passage 36 and manifold 20. Additionally, as FIG. 1D best shows, fuel-injection system 12 may include such a joint 70 that mates manifold 20 and passage 66; such a joint 72 that mates passages 66, 68; and such a joint 74 that mates passage 68 and fuel injector 48. In some embodiments, each joint 44, 46, 70, 72, 74 may have a configuration that accommodates independent variation of the angular relationship between the fuel-system components it mates about each of the X, Y, and Z axes while still providing a substantially fluid-tight seal between them. Additionally, as with joint 38, each joint 44, 46, 70, 72, 74 may provide a substantially fluid-tight seal between the fuel-system components mated thereby.

As with joint 38, each joint 44, 46, 70, 72, 74 may have various configurations that provide the above-described functions. In some embodiments, each of joints 44, 46, 70, 72, 74 may include a curved surface 40 on one fuel-system component abutted against a corresponding seat 42 on the other fuel-system component. Each curved surface 40 and corresponding seat 42 may have any of the configurations discussed above in connection with joint 38. As with joint 38, line contact between curved surface 40 and seat 42 of each of joints 44, 46, 70, 72, 74 may provide a substantially fluid-tight seal between the fuel-system components mated thereby.

Fuel-injection system 12 may employ various provisions for holding joints 38, 44, 46, 70, 72, 74 together. In some embodiments, fuel-injection system 12 may use adjustable clamps to hold one or more of joints 38, 44, 46, 70, 72, 74 together. For example, as FIG. 1C shows, an adjustable clamp 76 may hold joints 38, 44 together by clamping passage 34 between passage 36 and manifold 20, thereby clamping curved surface 40 and seat 42 of each of joints 38, 44 together. An adjustable clamp 78 may hold joint 46 together by clamping curved surface 40 and seat 42 of joint 46 against one another, such as by pressing on an end of passage 36 opposite joint 46. Additionally, as FIG. 1D shows, an adjustable clamp 80 may hold joints 70, 72 together by clamping passage 66 between passage 68 and manifold 20, thereby clamping curved surface 40 and seat 42 of each of joints 70, 72 together. Furthermore, an adjustable clamp 82 may hold joint 74 together by clamping curved surface 40 and seat 42 of joint 74 against one another, such as by pressing on an end of passage 68 opposite joint 74.

Each of adjustable clamps 76, 78, 80, 82 may have any configuration for applying an adjustable clamping force on the corresponding joints 38, 44, 46, 70, 72, 74. As FIGS. 1C and 1D best show, in some embodiments, each adjustable clamp 76, 78, 80, 82 may consist of a screw 88, 90, 92, 94 engaged to a threaded bore 96, 98, 100, 102 in cylinder head 18 and bearing on one or more of the fuel-system components it clamps together. This configuration allows adjusting the clamping forces on joints 38, 44, 46, 70, 72, 74 by turning screws 88, 90, 92, 94. As FIG. 1C shows, in some embodiments, threaded bore 98 of adjustable clamp 76 may substantially align with passage 34, and threaded bore 96 may have a minor diameter larger than the largest cross-section of passage 34. Additionally, threaded bore 98 may substantially align with passage 36, and threaded bore 98 have a minor diameter larger than the largest cross-section of passage 36. Similarly, as FIG. 1D shows, threaded bore 100 may substantially align with passage 66 and have a minor diameter larger than the largest cross-section of passage 66, and threaded bore 102 may substantially align with passage 68 and have a minor diameter larger than the largest cross-section of passage 68.

Each fuel injector 48, 49 may be any type of device operable to inject fuel into some part of engine 10. Each fuel injector 48, 49 may employ various types of actuation when injecting fuel, including, but not limited to, some combination of one or more of mechanical actuation, hydraulic actuation, pneumatic actuation, electrical actuation, and magnetic actuation. Each fuel injector 48, 49 may mount to engine 10 in a position such that it may inject fuel directly into a combustion chamber of engine 10. Alternatively, one or more of fuel injectors 48, 49 may mount to engine 10 in a position such that it may inject fuel into another portion of engine 10, such as an intake system (not shown) that supplies charge gas to the combustion chambers of engine 10.

Fuel-injection system 12 is not limited to the configuration shown in FIGS. 1A-1D. One or more of joints 38, 44, 46, 70, 72, 74 may have their curved surface 40 and corresponding seat 42 on the opposite fuel-system components compared to what FIGS. 1A-1D show. For example, rather than having curved surface 40 on passage 34 and seat 42 on pump 16, as FIG. 1C shows, joint 38 may have curved surface 40 on pump 16 and seat 42 on passage 34. Additionally, rather than a curved surface 40 abutting a seat 42, joints 38, 44, 46, 70, 72, 74 may have other configurations that allow variation in the angular relationship between the pair of fuel-system components mated thereby. Furthermore, in some embodiments, one or more of joints 38, 44, 46, 70, 72 74 may have a configuration that does not allow angular variation in the angular relationship between the pair of fuel-system components mated thereby. Moreover, fuel-injection system 12 may include a different number of joints between pump 16 and fuel injector 48 than FIGS. 1A-1D show. Additionally, one or more of adjustable clamps 76, 78, 80, 82 may have a different configuration that allows adjusting the clamping forcing on the associated joints 38, 44, 46, 70, 72, 74. Furthermore, fuel-injection system 12 may employ provisions other than an adjustable clamp to hold together one or more of joints 38, 44, 46, 70, 72, 74.

Fuel-injection system 12 may also include different numbers and/or configurations of fuel-system components than FIGS. 1A-1D show. For example, fuel-injection system 12 may also include one or more filters, valves, pressure regulators, and/or other suitable fuel-system components. In some embodiments, one or more components may serve as a fuel-system component while also serving other roles. For example, in some embodiments, in place of a separate component inserted in cylinder head 18, a passage formed directly in the parent material of cylinder head 18 may serve as manifold 20. Similarly, other passages formed directly in the parent material of cylinder head 18 or in other components, such as the block of engine 10, could form part of the path from pump 16 to fuel injector 48. In such embodiments, cylinder head 18 and/or any other components that directly carry fluid flowing to fuel injector 48 would constitute fuel-system components of fuel-injection system 12.

Additionally, in some embodiments, cylinder head 18 may not enclose one or more of injector-supply lines 56, 57, manifold 20, and main supply line 22. In some embodiments, fuel-injection system 12 may include one or more structures other than cylinder head 18 that enclose one or more of these parts of fuel-injection system 12. Alternatively, one or more of these parts of fuel-injection system 12 may not have an enclosure surrounding them.

Furthermore, the general configuration of fuel-injection system 12 may differ from that shown in FIGS. 1A-1D. For example, fuel-injection system 12 may omit one of fuel injectors 48, 49 or include more fuel injectors, in addition to fuel injectors 48, 49. Additionally, rather than having a single pump 16 that supplies multiple fuel injectors 48, 49, fuel-injection system 12 may include multiple pumps that each supply a single fuel injector.

### INDUSTRIAL APPLICABILITY

Fuel-injection system 12 may have application with any engine that combusts fuel. During operation, fuel-injection system 12 may supply fuel to engine 10 by discharging fuel from each fuel injector 48, 49 in a controlled manner. In order to do so, fuel-injection system 12 must supply fuel, and in some cases, one or more other fluids, to each fuel injector 48, 49.

Fluid source 15, pump 16, main supply line 22, manifold 20, and injector-supply lines 56, 57 collectively may supply fuel or another fluid to fuel injectors 48, 49. Fluid source 15 may supply fluid to inlet 28 of pump 16, and pump 16 may discharge at least a portion of that fluid from its outlet 30. Main supply line 22, manifold 20, and injector-supply lines 56, 57 may carry the fluid discharged from outlet 30 to fuel injectors 48, 49. Cylinder head 18 may contain any fluid that leaks from main supply line 22, manifold 20, and injector-supply lines 56, 57, and drain passage 24 may return any such fluid to fluid source 15.

Dependent upon what type of fluid injector-supply lines 56, 57 deliver, fuel injectors 48, 49 may do various things with the fluid. If injector-supply lines 56, 57 deliver fuel, fuel injectors 48, 49 may discharge the fuel for engine 10 to combust. If injector-supply lines 56, 57 deliver another fluid, fuel injectors 48, 49 may do various other things with it. For example, injector-supply lines 56, 57 may supply engine oil, and fuel injectors 48, 49 may use the engine oil to actuate various internal components when injecting fuel.

The disclosed embodiments may provide a number of advantages. For example, the combination of three angularly flexible joints 38, 44, 46 in the portion of fuel-injection system 12 from pump 16 to manifold 20 may accommodate variation in the relative positions of pump 16 and manifold 20 in the directions of the X, Y, and Z axes. Accordingly, joints 38, 44, 46 may fully accommodate manufacturing tolerances and component movement affecting the relative positions of pump 16 and manifold 20. Similarly, the combination of three angularly flexible joints 70, 72, 74 in the portion of fuel-injection system 12 from manifold 20 to fuel injector 48 may accommodate variation in the relative positions of manifold 20 and fuel injector 48 in the directions of the X, Y, and Z axes. Thus, joints 70, 72, 74 may fully accommodate manufacturing tolerances and component movement affecting the relative positions of manifold 20 and fuel injector 48.

These features of fuel-injection system 12 may reduce or eliminate the need to make fuel-system components in the portion of fuel-injection system 12 from pump 16 to fuel injector 48 flexible to accommodate manufacturing tolerances or component movement during operation. This may allow robust construction of the various fuel-system components between pump 16 and fuel injector 48, which may provide various advantages. For example, robustly constructed fuel-system components may facilitate pumping fluid to fuel injector 48 at very high pressures without any fuel-system components failing or leaking.

Additionally, employing adjustable clamps 76, 78, 80, 82 to hold joints 38, 44, 46, 70, 72, 74 together may also help seal joints 38, 44, 46, 70, 72, 74. Regardless of variation in component geometry stemming from manufacturing tolerances, adjustable clamps 76, 78, 80, 82 may be used to clamp joints 38, 44, 46, 70, 72, 74 with forces high enough to seal them, but not so high as to damage any fuel-system components. This may particularly facilitate sealing joints 38, 44, 46, 70, 72, 74 in applications where pump 16 pumps fluid to fuel injectors 48, 49 at relatively high pressures.

Furthermore, connecting two fuel-system components with a supply line that includes two passages connected at an angle may facilitate disconnecting the two fuel-system components without moving either of them. This configuration of supply line may provide this advantage because it may allow separating the two passages connected at an angle without moving either of them toward the spaces occupied by the fuel-system components connected by the supply line. For example, the configuration of injector-supply line 56 shown in FIGS. 1B and 1D may allow disconnecting fuel injector 48 from manifold 20 by loosening adjustable clamp 80, removing screw 94 from threaded bore 102, lifting passage 68 off of passage 66, and moving passage 68 away from fuel injector 48. The configuration of main supply line 22 may similarly allow disconnecting pump 16 and manifold 20 without moving them.

The ability to disconnect two fuel-system components without moving them may facilitate various maintenance tasks. For example, the ability to disconnect fuel injector 48 from manifold 20 without moving manifold 20 may allow separating fuel injector 48 from engine 10 for repair or replacement while leaving manifold 20 connected to fuel injector 49 by injector-supply line 57.

It will be apparent to those skilled in the art that various modifications and variations can be made in the fuel-injection system and methods without departing from the scope of the disclosure. Other embodiments of the disclosed fuel-injection system and methods will be apparent to those skilled in the art from consideration of the specification and practice of the fuel-injection system and methods disclosed herein. It is intended that the specification and examples be considered as exemplary only, with a true scope of the disclosure being indicated by the following claims and their equivalents.

What is claimed is:

1. A fuel-injection system for an engine, comprising:
a plurality of fuel-system components, including
a pump,
a fuel injector,
a plurality of fuel-system components connecting the pump to the fuel injector; and
wherein a portion of the fuel-injection system from the pump to the fuel injector includes
a first joint mating a first pair of the fuel-system components,
a second joint mating a second pair of the fuel-system components,
a third joint mating a third pair of the fuel-system components, and
each of the first joint, the second joint, and the third joint including a curved surface and a corresponding seat that are mated to one another and that provide a substantially fluid-tight seal and allow variation in the angular relationship between the associated pair of fuel-system components.

2. The fuel-injection system of claim 1, wherein:
the plurality of fuel-system components connecting the pump to the fuel injector includes a manifold and a plurality of fuel-system components connecting the manifold to the fuel injector; and
the first joint, the second joint, and the third joint are in a portion of the fuel-injection system from the manifold to the fuel injector.

3. The fuel-injection system of claim 2, wherein the manifold and the plurality of fuel-system components connecting the manifold to the fuel injector are substantially surrounded by an enclosure.

4. The fuel-injection system of claim 2, wherein:
the plurality of fuel-system components connecting the manifold to the fuel injector includes a first passage; and
the first pair of fuel-system components includes the manifold and the first passage.

5. The fuel-injection system of claim 2, wherein:
the plurality of fuel-system components connecting the manifold to the fuel injector includes a first passage and a second passage;
the first pair of fuel-system components includes the manifold and the first passage; and
the second pair of fuel-system components includes the first passage and the second passage.

6. The fuel-injection system of claim 5, further including an adjustable clamp holding the first joint and the second joint together by clamping the first passage between the second passage and the manifold.

7. The fuel-injection system of claim 1, wherein, in each of the first joint, the second joint, and the third joint, the curved surface has a substantially spherical shape and the corresponding seat has at least one substantially circular cross-section that the curved surface substantially makes line contact with to provide the substantially fluid-tight seal.

8. The fuel-injection system of claim 1, further including one or more adjustable clamps holding the first joint, the second joint, and the third joint together.

9. The fuel-injection system of claim 1, wherein:
the plurality of fuel-system components connecting the pump to the fuel injector includes a manifold; and
the first joint, the second joint, and the third joint are in a portion of the fuel-injection system from the pump to the manifold.

10. A method of connecting fuel-system components of a fuel-injection system for an engine, the fuel-system components including a pump, a fuel injector, and one or more fuel-system components for carrying fluid between the pump and the fuel injector, the method comprising:
mating a first pair of the fuel-system components with a first joint, including mating a first curved surface and a corresponding first seat that provide a substantially fluid-tight seal and allow variation in the angular relationship between the first pair of fuel-system components, wherein mating the first curved surface and the first seat includes clamping the first joint together with an adjustable clamp; and
mating a second pair of the fuel-system components with a second joint, including mating a second curved surface and a corresponding second seat that provide a substantially fluid-tight seal and allow variation in the angular relationship between the second pair of fuel-system components, wherein mating the second curved surface and the second seat includes clamping the second joint together with an adjustable clamp.

11. The method of claim 10, wherein:
the one or more fuel-system components for carrying fluid between the pump and the fuel injector include a manifold; and
the first joint and the second joint are in a portion of the fuel-injection system from the manifold to the fuel injector.

12. The method of claim 10, wherein the first pair of fuel-system components includes a manifold and a first passage.

13. The method of claim 12, wherein:
the second pair of fuel-system components includes the first passage and a second passage; and
clamping the first joint with an adjustable clamp and clamping the second joint with an adjustable clamp include clamping the first joint and the second joint with the same adjustable clamp by clamping the first passage between the second passage and the manifold.

14. The method of claim 10, wherein:
clamping the first joint with an adjustable clamp includes clamping the first joint with a first adjustable clamp; and
clamping the second joint with an adjustable clamp includes clamping the second joint with a second adjustable clamp.

15. The method of claim 10, wherein:
the first curved surface has a substantially spherical shape and the first seat has a substantially circular cross-section that the first curved surface substantially makes line contact with to provide the substantially fluid-tight seal; and
the second curved surface has a substantially spherical shape and the second seat has a substantially circular cross-section that the second curved surface substantially makes line contact with to provide the substantially fluid-tight seal.

16. A fuel-injection system for an engine, comprising:
a first fuel-system component;
a second fuel-system component;
a plurality of fuel-system components connecting the first fuel-system component and the second fuel-system component, including
a first passage,
a second passage connected to the first passage, the second passage extending at an angle to the first passage; and
wherein a portion of the fuel-injection system from the first fuel-system component to the second fuel-system component includes
a first joint mating a first pair of the fuel-system components,
a second joint mating a second pair of the fuel-system components, and
each of the first joint and the second joint including a curved surface and a corresponding seat that are mated to one another and that provide a substantially fluid-tight seal and allow variation in the angular relationship between the associated pair of fuel-system components.

17. The fuel-injection system of claim 16, wherein:
the first pair of fuel-system components includes the first fuel-system component and the first passage; and
the second pair of the fuel-system components includes the second fuel-system component and the second passage.

18. The fuel-injection system of claim 16, wherein:
the first fuel-system component is a pump; and
the second fuel-system component is a manifold.

19. The fuel-injection system of claim 16, wherein:
the first fuel-system component is a manifold; and
the second fuel-system component is a fuel injector.

20. The fuel-injection system of claim 16, further including one or more adjustable clamps clamping the first joint and the second joint together.
